(19) United States
(12) Patent Application Publication
(10) Pub. No.: US 2012/0064393 A1
(43) Pub. Date: Mar. 15, 2012

(54) BUTTON CELL AND METHOD FOR PRODUCTION THEREOF

(75) Inventors: Richard Schimmele, Jagstzell (DE); Christoph Glock Wagner, Ellwangen (DE); Horst Wagner, Rosenberg (DE)

(73) Assignee: VARTA MICROBATTERY GMBH, Ellwangen (DE)

(21) Appl. No.: 13/318,523

(22) PCT Filed: Mar. 16, 2010
(86) PCT No.: PCT/EP2010/053351

§ 371 Date: Nov. 9, 2011

(30) Foreign Application Priority Data
May 9, 2009 (DE) 10 2009 020 803.8

(51) Int. Cl. H01M 2/02; H01M 2/00; H01M 2/04

(52) U.S. Cl. 429/164; 29/623.1

(57) ABSTRACT

A button cell has a multiple-part housing for holding electrodes and a separator, wherein there is an interlocking connection between the housing and at least one of the electrodes, in particular the anode. A method for producing button cells includes a step wherein an electrode material is introduced into a housing half-part, the inside of which has at least one recess provided with at least one undercut to create an interlocking connection between the resultant electrode and the housing half-part.

### RELATED APPLICATIONS

This is a §371 of International Application No. PCT/EP2010/053351, with an international filing date of Mar. 16, 2010 (WO 2010/130480 A1, published Nov. 18, 2010), which is based on German Patent Application No. 10 2009 020 803.8, filed May 9, 2009, the subject matter of which is incorporated by reference.

### TECHNICAL FIELD

This disclosure relates to button cells having a multiple-part housing for holding electrodes and a separator, and also to a method which is suitable for the production of such button cells.

### BACKGROUND

Button cells having electrodes made of metals such as lithium, indium or a corresponding alloy are widely known. It is particularly preferable for lithium-aluminum alloys or else lithium-indium alloys to be used as the negative active electrode material in such button cells. Lithium-intercalating materials, such as, for example, LiMOₓ, where M=Co, Ni or Mn possibly doped, for example, with Al, Ti, Mg, Zn or Cr, graphite or lithium iron phosphate, are suitable as the positive active electrode material.

To produce such button cells, it is the case as a rule that the negative electrode materials are introduced into a corresponding negative housing half-part, whereas the positive electrode materials are introduced into an associated positive housing half-part. After a suitable electrolyte has been metered in and also, if appropriate, a separator has been mounted, the two housing half-parts can be assembled with the insertion of a seal. The cell can then be closed, in particular, by crimping.

However, a frequent problem in the case of such button cells is the connection of the electrodes, in particular, the connection of the metallic negative electrodes, to the housing. The metallic electrodes are usually stamped directly into the negative housing half-part mentioned, i.e., pressed in under pressure, but this alone still does not guarantee a good electrical connection to the housing. Instead, as an additional measure, an output conductor mesh is often welded into the negative housing half-part before the electrodes are stamped in. Alternatively, the negative electrode material can also be applied first to such a mesh (e.g., via electrodeposition) and only then be introduced together with the mesh into the housing half-part.

It could therefore be helpful to provide button cells of the type described in the introduction, in the case of which the negative electrode is connected to the housing more effectively than in the case of comparable known button cells, such that it is accordingly possible to dispense with technical aids such as the additional output conductor mesh mentioned.

### SUMMARY

We provide a button cell including a multiple-part housing for holding electrodes and a separator, wherein there is an interlocking connection between the housing and at least one of the electrodes.

We also provide a method for producing the button cell, wherein a housing half-part is provided, an inside portion of which has at least one recess provided with at least one undercut, and wherein an electrode material is introduced into the half-part to create an interlocking connection between the resultant electrode and the half-part.

### BRIEF DESCRIPTION OF THE DRAWINGS

FIGS. 1A, 1B and 1C show cross sections of the cell cover of a preferred button cell.

FIG. 2 shows a cross section of a first and a second impressing punch, with which it is possible to produce a cell cover shown in FIG. 1.

### DETAILED DESCRIPTION

Our button cells have a multiple-part housing which serves for holding electrodes and a separator. Compared to conventional button cells, however, our button cells are distinguished by the fact that there is an interlocking connection between the housing and at least one of the electrodes. The connection between this at least one electrode and the housing is therefore ensured at least partially by the interlocking of the at least one electrode and the housing. There is accordingly a mechanical connection between the at least one electrode and the housing which cannot be released without destruction or at least deformation of one of the two connection partners.

Preferably, the at least one electrode is the anode of the button cell. There is therefore preferably an interlocking connection between the housing and the anode of a button cell.

The anode is, in particular, a metallic anode, in particular a metallic anode as has already been mentioned above. It is particularly preferable for electrodes containing metallic lithium or metallic indium or electrodes consisting of these materials to be used, although zinc anodes are also suitable in principle, for example. Accordingly, the button cell can be a zinc-air cell or a lithium cell, for example.

The multiple-part housing of a button cell preferably comprises two housing half-parts, in particular a cell cup and a cell cover, it being preferable for the at least one electrode, in particular the anode, to be connected to the cell cover in an interlocking manner. The cell cover is therefore preferably a negative housing half-part, as has already been mentioned above.

A mesh like that for the negative housing half-part mentioned is superfluous in our button cells. Preferably, our button cells accordingly have a negative electrode in a negative housing half-part without an additional output conductor mesh. The negative electrode is connected directly to the housing via the interlocking connection mentioned.

Particularly preferably, our button cells are distinguished by the fact that they have a housing half-part, in particular a cell cover, the inside of which has at least one recess provided with an undercut. This recess is preferably at least partially filled with electrode material, preferably with the material of the anode, in particular such that the at least one electrode, in particular the anode of the button cell, engages behind the at least one undercut. It is therefore possible for the interlocking connection mentioned between the at least one electrode and the housing to be realized.

The at least one recess is preferably part of a three-dimensional impression on the inside of the housing half-part or cell cover. The at least one recess is therefore preferably formed by a forming process, in particular an impressing process.

It is particularly preferable for the at least one recess, in particular the impression with the at least one recess, to be located in the region of the bottom of the housing half-part, in particular in the region of the bottom of the cell cover of the button cell. Cell covers suitable for our button cells generally have such a cover bottom which generally has a substantially planar form and, during operation, forms a pole of the button cell from which current can be drawn by a load. A circumferential casing region and/or a circumferential edge region generally adjoin this, preferably planar, bottom region. The casing region preferably has a cylindrical form. The edge region usually comprises a cut edge, which if appropriate can be bent outward or inward.

It is preferable that the second housing half-part of the button cell, the cell cup, also has an analogous structure.

It is the case as a rule that the cell cup and the cell cover are connected via a seal. By way of example, this may involve an injection-molded part or else a film seal. Suitable seals are known.

In principle, the at least one recess mentioned above can have any desired geometry. Punctiform recesses as well as elongate recesses are suitable. The latter are preferred, however, and therefore the at least one recess is, in particular, at least one elongate recess in the manner of a groove or a notch.

In principle, the arrangement of the at least one recess on the inside of the housing half-part is arbitrary. However, it is preferable for the at least one recess to form a regular pattern. Thus, it is particularly preferable for the at least one recess to be concentrically arranged circular grooves.

In principle, the cross section of the at least one recess, too, can have the widest variety of geometries. However, it is particularly preferable for the at least one recess to have a substantially (apart from the undercut) rectangular or pentagonal cross section. More details will be given in this respect hereinbelow, however.

The at least one undercut is preferably formed by a protrusion or a bead which extends along the top edge of the at least one recess. In the region of this protrusion or this bead, the cross section of the at least one recess is constricted compared to at least one deeper-lying region of the recess.

The housing of the button cell preferably consists of one or more metals. Nickel-plated deep-drawn metal sheet or else a trimetal, for example, can be used with particular preference as the housing material. Suitable materials are known.

The depth of the at least one recess preferably amounts to 5% to 50% of the thickness of the housing of the button cell, where the maximum thickness of the housing in the region of the cup bottom, in particular, serves as the reference variable. With particular preference, the depth of the at least one recess is 5% to 25% of the thickness of the housing in this region.

As already mentioned above, we also provide a method by which the described button cells can be produced.

In our method, a housing half-part, in particular a housing cover, is provided, the inside of which has at least one recess provided with at least one undercut. Such housing half-parts have already been described above; reference is hereby made to the corresponding explanations.

In particular, our method is distinguished by the fact that an electrode material, in particular an anode material, is introduced into such a housing half-part to create an interlocking connection between the resultant electrode and the housing cover.

This is preferably effected by introducing, in particular pressing, the electrode material under pressure into the housing half-part, in particular the cover. Here, the pressure has to be sufficiently high for the electrode material to fill the at least one recess up to behind the undercut, such that the material engages behind the undercut and the desired interlocking connection is therefore established. The pressure required for this depends on the properties, in particular the hardness and deformability, of the respective electrode material. An interlocking connection can therefore be achieved even at very low pressures with the relatively soft lithium-indium alloys.

Alternatively, the electrode material can be introduced into the housing half-part, for example, by deposition from an electrolyte.

After the electrode has been introduced, the housing half-part can be combined with a corresponding second half-part, and these can be assembled to form a button cell. As described in the introduction, the button cell can be closed, for example, by crimping the two housing parts, with the further components of the button cell, such as, for example, the separator or a suitable electrolyte, of course also being introduced, if appropriate, before the button cell is closed.

Housing half-parts preferably built by our method are produced, inter alia, via an impressing process. Such an impressing process may be a substep of the method, but independently thereof it is also a part of this disclosure.

To produce a suitable housing half-part, at least one first recess is impressed with particular preference into an unmachined housing half-part using a first impressing punch. This at least one first recess can have a rectangular or pentagonal cross section, for example, depending on the impressing punch used. In a further step, the at least one undercut is then produced using a second impressing punch. For this purpose, the second impressing punch is used with preference to impress at least one further recess into the housing half-part, to be precise such that, during impressing, the cross section of the at least one first recess is constricted, in particular in the region of the top edge of the recess. In other words, the at least one further recess is impressed so close to the at least one first recess that the edge or edges of the first recess is or are pressed inward.

This at least one further recess can have a wedge-shaped cross section, for example, depending on the impressing punch used, although the geometry of the cross section of the at least one further recess is in principle irrelevant. The at least one further recess serves merely to provide the at least one first recess with at least one undercut.

This procedure and also the advantages already mentioned and further advantages are also apparent from the following description of the drawings. Here, individual features can be implemented on their own or in combination with one another. The examples described serve merely for explanation and for better understanding and are in no way to be understood as having a limiting effect.

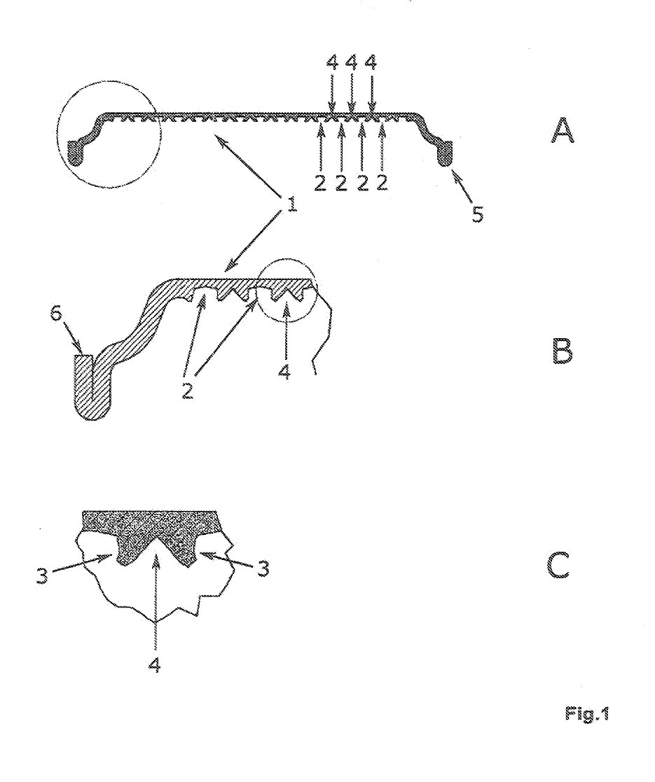

FIG. 1 shows a cross section of a cell cover 1 of a preferred button cell, first in its entirety (1A) and second in enlarged sections (1B and 1C). The section 1C corresponds to the partial section encircled in section 1B, and the section 1B corresponds in turn to the partial section encircled in the overall illustration 1A.

The overall illustration 1A shows the overall cross section of the cell cover 1, with a circumferential edge 5 with an outwardly turned cut edge 6 and also a substantially circular and planar bottom region. The inside of the latter has a regular sequence of recesses 2 and 4. In first approximation, the recesses 2 have a substantially rectangular cross section, and the recesses 4 have a substantially wedge-shaped cross section. A wedge-shaped recess 4 is arranged between two respective adjacent recesses 2.

In illustrations 1B and 1C, the recesses 2 with the at least one undercut 3 are shown on an enlarged scale. It becomes clear in the enlarged illustration that the bottom of the recesses 2 does not have a completely planar form, but instead slopes slightly toward the center of the recesses 2. The cross section of the recesses 2, which in first approximation is substantially rectangular, can therefore also be described as substantially pentagonal. The undercuts 3 are also readily visible and are formed by the edges of the recesses 2 being pressed inward slightly, which is a consequence of the wedge-shaped recesses 4. The edges of the recesses 2 form a protrusion which constricts the cross section of the recesses 2 at the top edge thereof. If, for example, a metallic electrode is pressed under pressure against the inside of the cell cover bottom, electrode material can penetrate into the recesses 2, the result being an electrode which engages behind the undercuts 3 and is connected directly to the cell cover 1 in an interlocking manner.

Preferably as mentioned above, the recesses 2 form a regular pattern on the inside of the cell cover, i.e., they are arranged in the form of circles arranged concentrically to one another, with a circular recess 4 having a wedge-shaped cross section being arranged between two respective recesses 2 with an undercut. Both the recesses 2 and the recesses 4 are therefore elongate recesses in groove form.

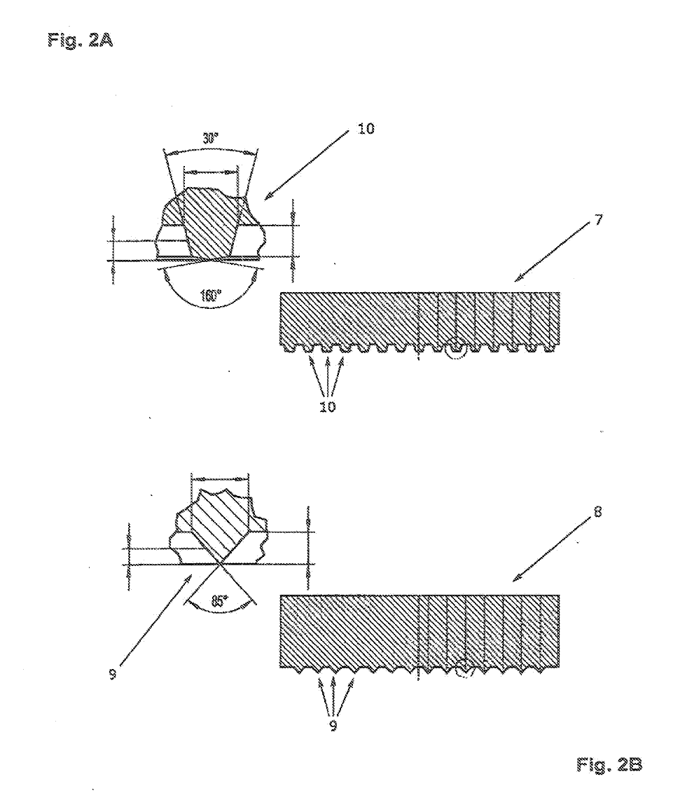

FIG. 2 shows a cross section of a first and a second impressing punch 7 and 8, with which it is possible to produce a button cell cover as shown in FIG. 1. Each of the two punches has a main body. In the case of the impressing punch 8, the latter bears wedge-shaped elevations 9 with a cross section corresponding substantially to the cross section of the recesses 4, whereas the impressing punch 7 has substantially pentagonal elevations 10. The elevations 9 and 10 are each also shown on an enlarged scale.

In a first step, the impressing punch 7 can be used to impress recesses with a substantially pentagonal or rectangular cross section into a cell cover. Then, the impressing punch 8 can be used to introduce the recesses 4 with a wedge-shaped cross section into the cell cover, the dimensions and radii of the wedge-shaped elevations 9 on the impressing punch 8 being adapted to the dimensions and radii of the recesses impressed in the first step (or the dimensions and radii of the elevations 10 on the impressing punch 7) such that a recess with a wedge-shaped cross section is impressed between two respective recesses with a pentagonal or rectangular cross section. During the impressing process using the impressing punch 8, the edges of the recesses with a pentagonal cross section, impressed in the first step, are pressed slightly inward, in which case the undercuts 3 are created and therefore the cross section of the recesses 2 is ultimately determined.

1-15. (canceled)

16. A button cell comprising a multiple-part housing for holding electrodes and a separator, wherein there is an interlocking connection between the housing and at least one of the electrodes.

17. The button cell according to claim 16, wherein there is an interlocking connection between the housing and the anode.

18. The button cell as claimed in claim 17, wherein the anode is a metallic anode.

19. The button cell as claimed in claim 17, wherein the anode contains metallic lithium or metallic zinc.

20. The button cell as claimed in claim 16, wherein the multiple-part housing comprises a cell cup and a cell cover.

21. The button cell as claimed in claim 20, wherein the anode is connected to the cell cover in an interlocking manner.

22. The button cell as claimed in claim 20, wherein an inside portion of the cell cover has at least one recess provided with at least one undercut.

23. The button cell as claimed in claim 22, wherein the at least one recess is part of a three-dimensional impression on the inside of the cell cover.

24. The button cell as claimed in claim 22, wherein the cell cover has the at least one recess in a region of the cover bottom.

25. The button cell as claimed in claim 22, wherein the at least one recess is at least one elongate recess.

26. The button cell as claimed in claim 22, wherein the at least one recess is at least one groove or notch.

27. The button cell as claimed in claim 22, wherein the at least one recess forms a regular pattern.

28. The button cell as claimed in claim 22, wherein the at least one recess is concentrically arranged circular grooves.

29. The button cell as claimed in claim 22, wherein the at least one recess has a substantially rectangular or pentagonal cross section.

30. The button cell as claimed in claim 16, wherein the housing consists of metal.

31. The button cell as claimed in claim 22, wherein depth of the at least one recess is 5% to 50% of thickness of the housing in relation to thickness of the housing in a region of the cup bottom.

32. A method for producing a button cell as claimed in claim 16, wherein a housing half-part is provided, an inside portion of which has at least one recess provided with at least one undercut, and wherein an electrode material is introduced into the half-part to create an interlocking connection between the resultant electrode and the half-part.

33. The method as claimed in claim 32, wherein the electrode material is pressed into the cover.

34. The method according to claim 32, wherein, to provide the housing half-part, at least one first recess is impressed into an unmachined housing half-part using a first impressing punch, and the at least one first recess produced is provided with at least one undercut wherein a second impressing punch is used to impress at least one second recess into the housing half-part such that a cross section of the at least one first recess is constricted.
